(19) United States
(12) Patent Application Publication
(10) Pub. No.: US 2018/0162241 A1
(43) Pub. Date: Jun. 14, 2018

(54) DOOR ARM-REST FOR VEHICLES

(71) Applicants: Hyundai Motor Company, Seoul (KR); Kia Motors Corporation, Seoul (KR)

(72) Inventors: Kyung Soon JANG, Ansan-si (KR); Jesun HAN, Hwaseong-si (KR); Dong Han KIM, Yongin-si (KR); Woonpyo LEE, Seongnam-si (KR); Jun Ho LEE, Yongin-si (KR); Jehyoung CHUN, Bucheon-si (KR); MinJung KIM, Hwaseong-si (KR); Eui Chan CHO, Suwon-si (KR); WonSeok JUN, Seongnam-si (KR); JinRo KIM, Seoul (KR)

(73) Assignees: Hyundai Motor Company, Seoul (KR); Kia Motors Corporation, Seoul (KR)

(21) Appl. No.: 15/610,236

(22) Filed: May 31, 2017

(30) Foreign Application Priority Data
Dec. 13, 2016 (KR) 10-2016-0169849

(51) Int. Cl. B60N 2/46

(52) U.S. Cl. CPC B60N 2/466

(57) ABSTRACT

A door arm-rest for vehicles may include a core forming appearance having an outside surface and an inside surface and combined with a door trim and a skin surrounding the core, wherein an upper surface of the core includes a plurality of cushion plates having a same polygonal section which respective neighboring sides are spaced apart in parallel with each other in a constant interval, and a plurality of bridges connecting the respective neighboring sides of the respective cushion plates.

### CROSS-REFERENCE(S) TO RELATED APPLICATIONS

The present application claims priority to Korean Patent Application No. 10-2016-0169849 filed on Dec. 13, 2016, the entire contents of which are incorporated herein for all purposes by this reference.

### BACKGROUND OF THE INVENTION

### Field of the Invention

The present invention relates to a door arm-rest for vehicles. More particularly, the present invention relates to a door arm-rest for vehicles which improves the feeling of cushion and comfort.

### Description of Related Art

Generally, a door of a vehicle is combined with the body for getting in and out of the vehicle by a hinge to be opened and closed, and a door arm-rest is disposed on an interior surface of the door for mounting a passenger's arm.

The door arm-rest commonly is a structure that includes a core which forms the whole appearance and having a high durability due to a combination with the door trim, and a skin surrounding the core.

Meanwhile, the door arm-rest has a main function of comfort when the passenger's arm is mounted upon; therefore the door arm-rest has to have high durability so that a load is sufficiently endured.

However, the door arm-rest in the conventional art has a core wherein an upper surface is formed flatly; therefore sufficient deformation does not occur when the passenger mounts his or her arm.

The information disclosed in this Background of the Invention section is only for enhancement of understanding of the background of the invention and should not be taken as an acknowledgement or any form of suggestion that this information forms the prior art already known to a person skilled in the art.

### BRIEF SUMMARY

Various aspects of the present invention are directed to providing a door arm-rest for vehicles which improves the feeling of cushion and comfort according to an upper surface of a core, which includes a plurality cushion plates and a plurality of bridges which are deformed partially.

In various exemplary embodiments of the present invention, a door arm-rest for vehicles is a structure including a core forming appearance having an external surface and an internal surface and combined with a door trim and a skin surrounding the core. The upper surface of the core includes a plurality of cushion plates having the same polygonal section wherein respective neighboring sides are spaced apart in parallel with each other in a constant interval, and a plurality of bridges connecting the respective neighboring sides of the respective cushion plates.

Further, the polygonal section may be a hexagonal section.

Further, the cushion plate may have an external portion which is connected to the outside surface and the inside surface of the core through the bridge.

Further, the bridge may be formed as a ‘U’ shape and the upper side end portions may be connected to the corresponding sides of the neighboring two cushion plates.

Further, a space portion may be formed between the bridge and the bridge.

Further, a pad may be interposed between the core and the skin.

According to an exemplary embodiment of the present invention, the door arm-rest for vehicles improves the feeling of cushion and comfort according to an upper surface of a core which includes a plurality cushion plates and a plurality of bridges which are deformed partially.

That is, when the passenger mounts his or her arm on the door arm-rest for vehicles, the plurality of cushion plates and bridges act as springs to absorb a load through deformation, therefore the feeling of cushion may be improved.

The methods and apparatuses of the present invention have other features and advantages which will be apparent from or are set forth in more detail in the accompanying drawings, which are incorporated herein, and the following Detailed Description, which together server to explain certain principles of the present invention.

### BRIEF DESCRIPTION OF THE DRAWINGS

FIG. 1 is an applied perspective view of a door arm-rest for vehicles according to an exemplary embodiment of the present invention.

FIG. 2 is a partial perspective view of a door arm-rest for vehicles according to an exemplary embodiment of the present invention.

FIG. 3 is a rear perspective view of a door arm-rest for vehicles according to an exemplary embodiment of the present invention.

FIG. 4 is a cross-sectional view according to line A-A of FIG. 1.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

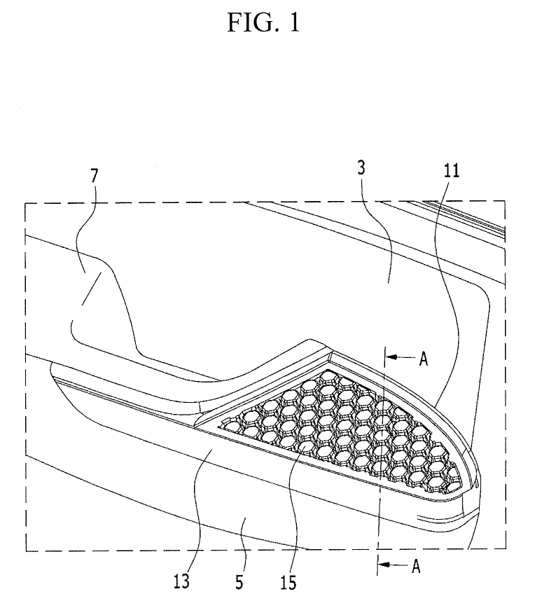

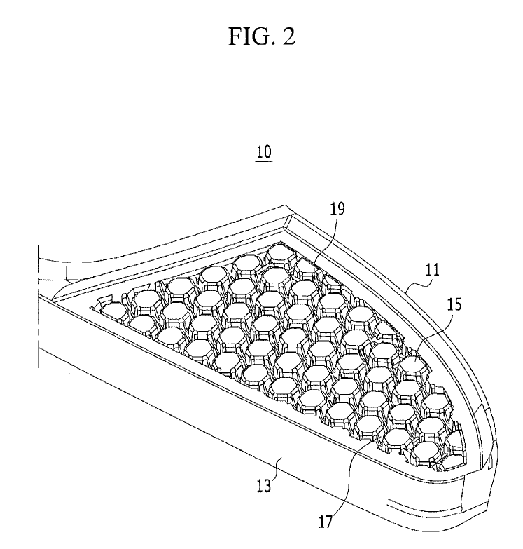

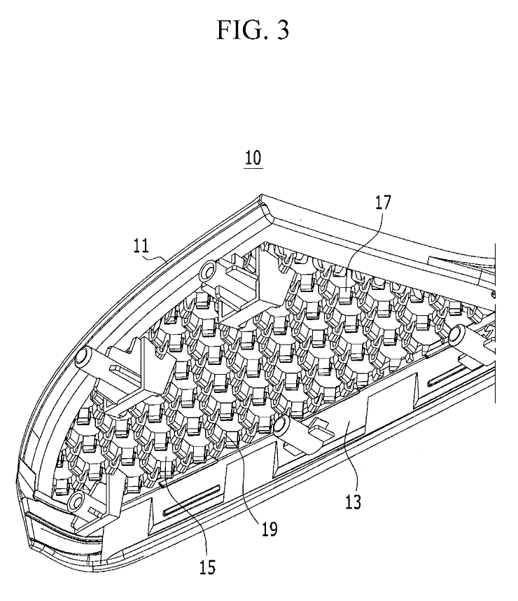

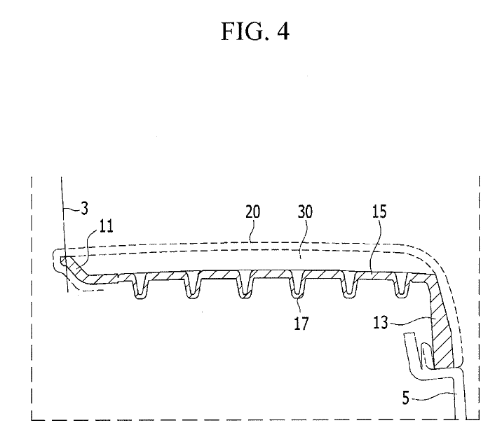

FIG. 1 is an applied perspective view of a door arm-rest for vehicles according to an exemplary embodiment of the present invention. FIG. 2 is a partial perspective view of a door arm-rest for vehicles according to an exemplary embodiment of the present invention. FIG. 3 is a rear perspective view of a door arm-rest for vehicles according to an exemplary embodiment of the present invention, and FIG. 4 is a cross-sectional view according to line A-A of FIG. 1.

Referring to FIG. 1, a door arm-rest for vehicles according to an exemplary embodiment of the present invention is formed on a door trim wherein the passenger's arm is configured to be mounted on an internal surface of the door.

That is, the door arm-rest is formed at certain sections of which a center trim 3 and a lower trim 5 are connected to each other.

In other words, the door arm-rest is disposed at one side between the center trim 3 and lower trim 5, and the pull handle 7 is disposed adjacent to the door arm-rest, therefore the door handle has a function of closing an open door.

The present door arm-rest may be a structure including a core 10 and a skin 20.

The core 10 forms the entire appearance and is combined with the center trim 3 and lower trim 5 to have high durability.

At the present time, when passenger mounts his or her arm on the core 10 and a load is applied, a deformation of shape happens and the load is absorbed.

Further, the skin 20 surrounds and is combined with the core 10, and is formed from a soft material to improve the feeling of touch when in contact with the passenger.

The pad 30 may be interposed between the core 10 and the skin 20.

At the present time, the pad 30 may include Styrofoam or sponge material, and be formed to improve the feeling of cushion with the core 10.

Here, the core 10 according to an exemplary embodiment of the present invention includes an outside surface 11 formed as a curved shape for being combined with the center trim 3 and the pull handle 7 and an inside surface 13 combined with the lower trim 5 in state of being connected to the outside surface 11 and formed lengthwise along a longitudinal direction of a vehicle body.

Further, the core 10, referring to FIG. 2 to FIG. 4, includes a cushion plate 15 having a plurality of upper surfaces and a plurality of bridges 17.

First, the cushion plates 15 are formed in plural to form upper surfaces of the core 10, and neighboring angles of the cushion plates 15 are formed in parallel.

The cushion plates 15 have a same polygonal section and are spaced apart in a constant interval.

At the present time, the polygonal section is a hexagonal section to create a honeycomb structure.

While the present invention have been described that the polygonal section is formed as hexagonal section, the invention is not limited to the described embodiments, but the polygonal shape may be modified when required.

For example, the polygonal section may be formed as a square section.

Also, the polygonal section may be formed as a pentagonal section.

Meanwhile, the bridge 17 connects neighboring sides of the respective cushion plates 15.

The bridge 17 has upper side end portions connected to corresponding sides of the neighboring two cushion plates.

This bridge 17 may be formed as a ‘U’ shape.

The bridge 17 has straight rod members which have the same area and are bent to be interposed between the cushion plate 15.

Also, a space portion 19 is formed between the bridge 17 and the bridge 17.

The present bridge 17 deforms through the space portion 19 when pressure is applied to the bridge 17.

The core 10 having the cushion plate 15 and bridge 17 as described above may be formed integrally through injection molding.

Also, the core 10 may be formed wherein the cushion plate 15 and bridge 17 may be combined with each other by being made as separate objects.

Accordingly, the door arm-rest according to an exemplary embodiment of the present invention has durability sufficiently enduring load when the passenger's arm is mounted on.

That is, when the passenger mounts his or her arm on the door arm-rest for vehicles, the cushion plate 15 and bridge 17 acts as springs to be deformed partially.

Further, the cushion plate 15 and bridge 17 are distributed on the entire upper surface of the core 10 to have same deformation amount regardless of location.

Accordingly, feeling of cushion of the door arm-rest for vehicles is improved to have increased product quality.

For convenience in explanation and accurate definition in the appended claims, the terms “upper”, “lower”, “internal”, “outer”, “up”, “down”, “upwards”, “downwards”, “front”, “rear”, “back”, “inside”, “outside”, “inwardly”, “outwardly”, “internal”, “external”, “forwards” and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A door arm-rest apparatus for vehicles being a structure including a core forming appearance having an outside surface and an inside surface and combined with a door trim and a skin surrounding the core,
wherein an upper surface of the core includes:
a plurality of cushion plates having a same polygonal section which respective neighboring sides are spaced apart in parallel with each other in a constant interval; and
a plurality of bridges connecting respective neighboring sides of respective cushion plates.

2. The door arm-rest apparatus for vehicles of claim 1, wherein the polygonal section is hexagonal section.

3. The door arm-rest apparatus for vehicles of claim 1, wherein the cushion plate has an external portion which is connected to the outside surface and the inside surface of the core through the bridges.

4. The door arm-rest apparatus for vehicles of claim 1, wherein the bridge is formed as a ‘U’ shape and upper side end portions are connected to corresponding sides of the neighboring two cushion plates.

5. The door arm-rest apparatus for vehicles of claim 1, wherein a space portion is formed between the bridges.

6. The door arm-rest apparatus for vehicles of claim 1, wherein a pad is interposed between the core and the skin.
